(19) United States
(12) Patent Application Publication
(10) Pub. No.: US 2010/0092855 A1
(43) Pub. Date: Apr. 15, 2010

(54) Battery Pack Apparatus For Electric Window Coverings

(76) Inventor: Li-Ming CHENG, Kaohsiung City (TW)

Correspondence Address: FRENKEL & ASSOCIATES, 3975 UNIVERSITY DR., STE. 330, FAIRFAX, VA, 22030, US

(21) Appl. No.: 12/250,761

(22) Filed: Oct. 14, 2008

(51) Int. Cl. H01M 2/02

(52) U.S. Cl. 429/163

(57) ABSTRACT

A battery pack apparatus for electric window coverings coupling with a clutch installed on one side of an upper rail of a window shade includes a battery pack housing below the clutch and a battery pack held in the battery pack housing. The battery pack has a retaining assembly element at one end and an elastic thrust element at a distal end thereof lock or unlock with a latch assembly element at an opposing end of the battery pack housing. Thereby the battery pack can be loaded or unloaded easily to change batteries to facilitate retracting and extending operation of the window shade.

### FIELD OF THE INVENTION

The present invention relates to a battery pack apparatus for electric window coverings and particularly to a battery pack which has a retaining assembly element at one end with an elastic thrust element coupled at a distal end thereof and a battery pack housing with a latch assembly element at an opposing end lock or unlock with the retaining assembly element to facilitate replacement of batteries.

### BACKGROUND OF THE INVENTION

R.O.C. Patent Pub. No. 507827, referring to FIG. 1, discloses an electric window shade 10 which mainly includes an upper rail 11, a lower rail 12, collectable slats 13 between the upper and lower rails 11 and 12, and a plurality of lift cords linking the collectable slats 13. The upper rail 11 holds an electric transmission device 14 which includes an electronic control assembly element (not shown in the drawing), a motor 141 and a transmission rod 142. The transmission rod 142 is coupled with the lift cords and operable through the motor 141. The upper rail 11 further has a battery chamber 111 to hold batteries 15 and a battery lid 112 detachably mounted on the battery chamber 111 to provide electric power to the electric transmission device 14.

When in use, through the electronic control means of the electric transmission device 14 the motor 141 can be activated to rotate the transmission rod 142 to lift and retract, or lower and extend the slats 13 through the lift cords, thereby to block light or serve ornamental purpose.

The aforesaid electric window shade 10 still has drawbacks in use, notably:

When users want to change the batteries 15, they have to remove the battery lid 112, change the batteries 15, and install the battery lid 112 again. As the battery chamber 111 is located on the upper rail 11 which is generally installed on a location spaced from the floor at a distance, the users have to raise hands to do the activities mentioned above. Changing the batteries 15 is difficult. In the event that users' physical height cannot reach the upper rail, they have to step onto a chair or the like to do replacement of the batteries 15. It is troublesome or even risky.

### SUMMARY OF THE INVENTION

The primary object of the present invention is to provide a battery pack apparatus for electric window coverings to solve the problem of conventional electric window shade that is difficult to change batteries. The present invention includes a battery pack with a retaining assembly element at one end and a battery pack housing with a latch assembly element at an opposing end thereof that can be disengaged by a simple push of the battery pack. Thus it makes removing of the battery pack to change batteries much easier. The battery pack also can be loaded into the battery pack housing, and by another push of the battery pack the retaining assembly element and the latch assembly element can be engaged to finish installation.

Another object of the invention is to provide a battery pack apparatus for electric window coverings that allows the battery pack to be removed when batteries are exhausted and the electric window shade to become a cordless window shade extendable or retractable manually.

To achieve the foregoing objects, the battery pack apparatus according to the invention is installed on an upper rail of a window shape coupling with a clutch at one side thereof. It has a battery pack housing below the clutch and a battery pack held in the battery pack housing. The battery pack has a retaining assembly element at one end with an elastic thrust element coupled on a distal end thereof, and a latch assembly element at an opposing end of the battery pack housing that can be latched together or separated from each other.

In another aspect the clutch has a contact element. When the battery pack is loaded or unloaded from the battery pack housing the contact element is pushed or released, and the clutch and a driving means (such as a motor) are coupled or disengaged.

By means of the battery pack apparatus set forth above the invention can achieve the following effects: 1. with the design of coupling the clutch at one side of the upper rail with the battery pack, battery changing is easier; 2. with the retaining assembly element and elastic thrust element at one end of the battery pack and latch assembly at the opposing end of the battery pack housing that are latchable and separable, replacement of batteries is simpler; 3. in the event of losing electric power the battery pack can be removed to make the electric window shade to become a cordless window shade that can be extended or retracted manually.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional electric window shade.

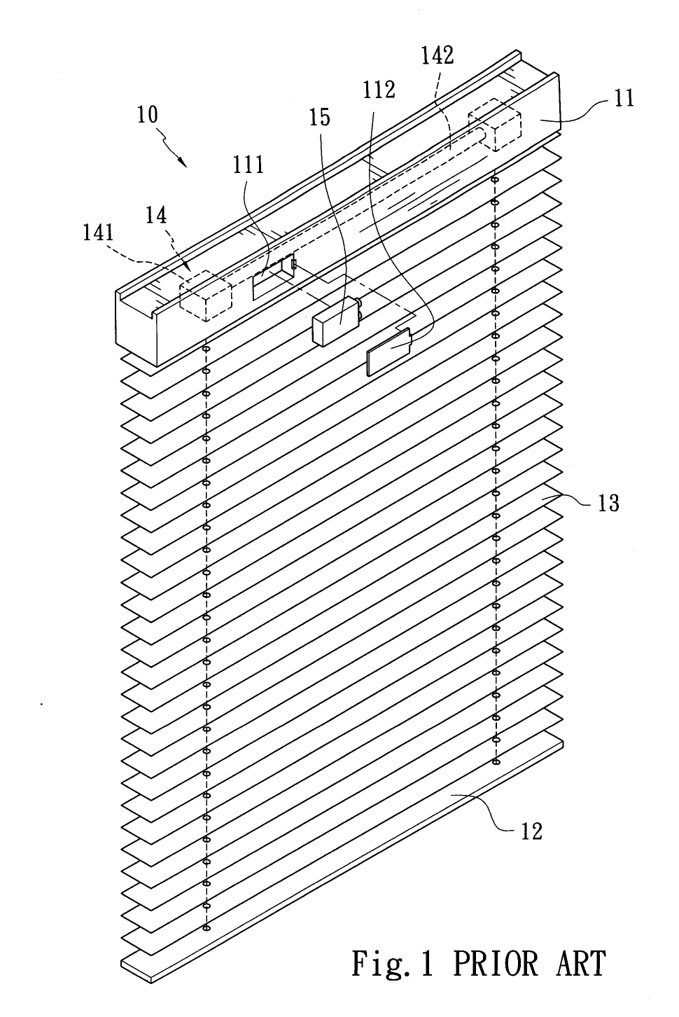

FIG. 2 is a perspective view of the invention.

FIG. 3 is a schematic view of the battery pack apparatus and upper rail viewed from a lower side.

FIG. 4 is an exploded view of the battery pack apparatus of the invention viewed from a lower side.

FIG. 5 is a schematic side view of the battery pack apparatus in an assembling condition.

FIG. 6 is a schematic side view of the battery pack apparatus in an assembled and use condition.

FIG. 7 is an exploded view of the battery pack and battery pack housing to form electric connection.

FIG. 8 is a schematic view of the invention in a use condition with the battery pack removed.

### DETAILED DESCRIPTION OF THE PREFERRED EMBODIMENTS

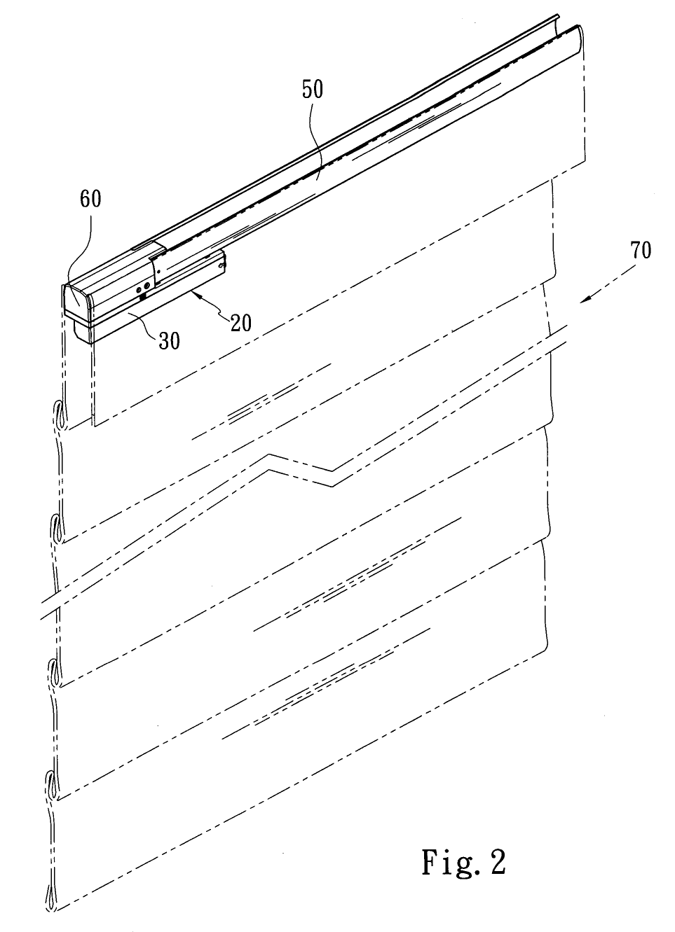

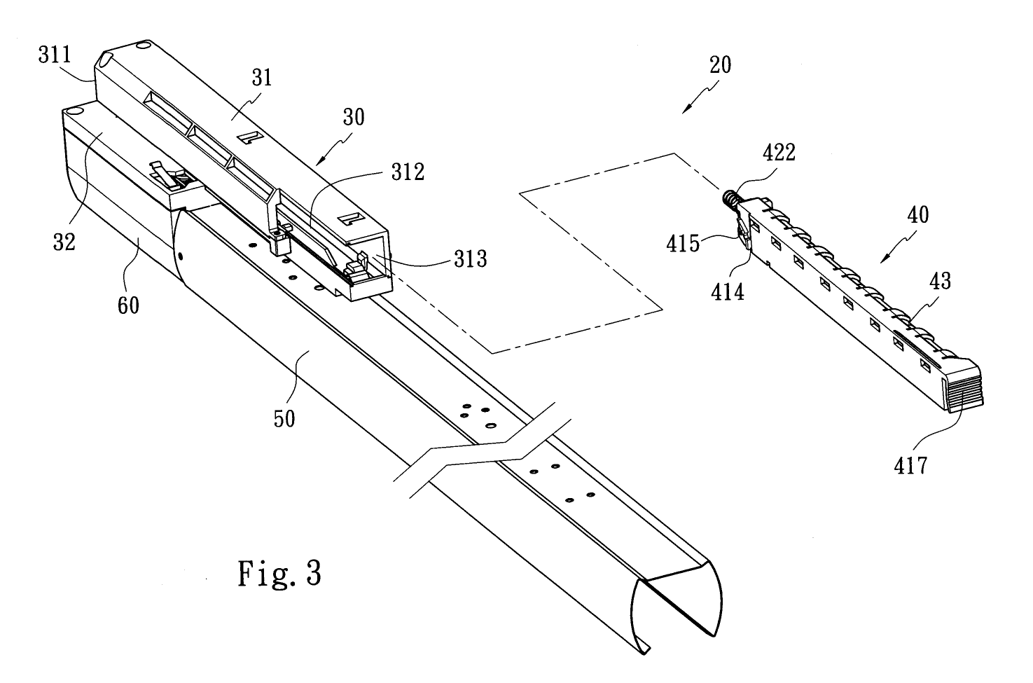

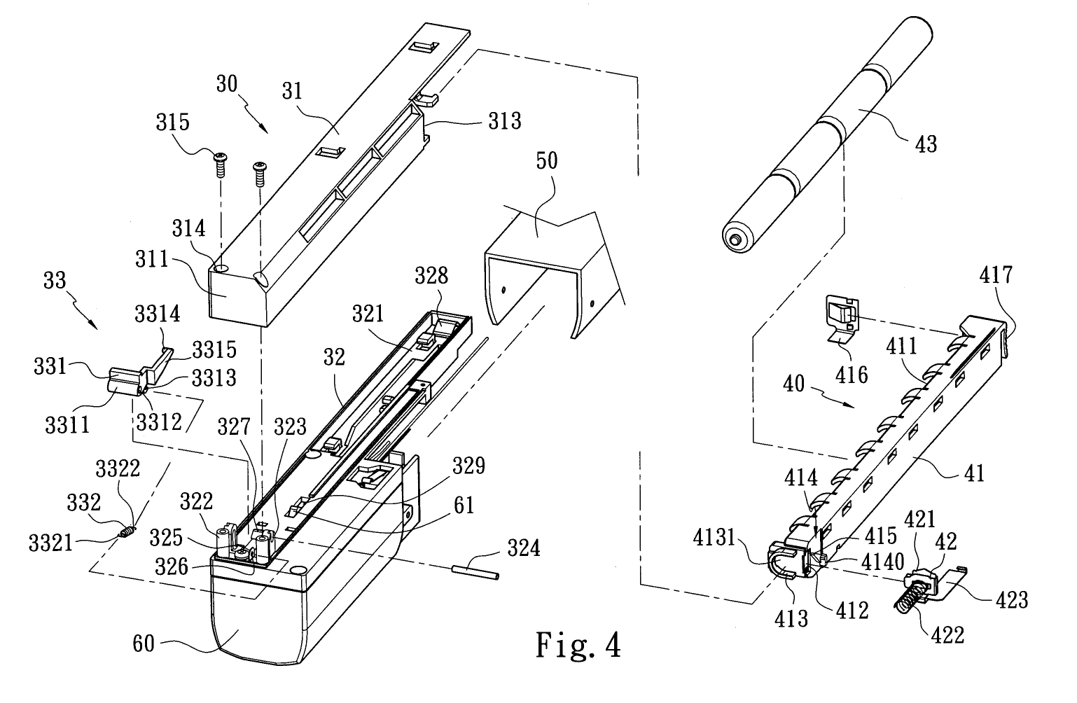

Please referring to FIGS. 2 through 5, the present invention aims to provide a battery pack apparatus 20 for an electric window shade 70. It is installed on an upper rail 50 of the window shade coupling with a clutch 60 at one side of the upper rail 50. It includes a battery pack housing 30 is located below a clutch 60 and a battery pack 40 held in the battery pack housing 30.

The battery pack housing 30 has a base 31, a battery lid 32 and a latch assembly element 33. The battery lid 32 and the base 31 are coupled to form a housing compartment 312 and an opening end 313 at one end leading to the housing compartment 312, and a closed end 311 at another end. Plurality fastening holes 314 close to the closed end 311 are provided to receive fastening elements 315 to fasten the battery lid 32. The battery lid 32 has an opening 321 facing downwards to be coupled with the base 31 for fastening. The battery lid 32 further has a coupling strut 322 corresponding to the fastening hole 314 on each of two sides thereof. There is a hinge element 323 on the abutting sides of the coupling struts 322 to be coupled with a rocker bar 331 of the latch assembly element 33 through a pin 324. A latch element 325 is provided between the two coupling struts 322 with a latch hole 326 formed thereon to be latched by a hook end 3321 of one end of an elastic element 332. The battery lid 32 also has two ends with respectively a first electric contact end 327 and a second electric contact end 328 located thereon, and a slot 329 at an inner side close to the first electric contact end 327 to allow a contact element 61 of the clutch 60 to bulge out. The latch assembly element 33 is hinged on one end of the battery lid 32, and has the rocker bar 331 and the elastic element 332. The rocker bar 331 has a coupling end 3311 at one side with a hole 3312 formed thereon. The rocker bar 331 is held between the two hinge elements 323 and has the hole 3312 run through by the pin 324 to form pivotal coupling so that the rocker bar 331 is shiftable about the pin 324. The rocker bar 331 further has a hook 3313 at the bottom end close to the coupling end 3311 to be latched by another end 3322 of the elastic element 332, and a latch arm 3315 at another side with a latch member 3314 formed thereon.

The battery pack 40 includes a battery seat 41 and a wedge plate 42. The battery seat 41 has a housing chamber 411 to hold at least one battery 43, and a latch trough 412 at one end and a detent flange 413 on the periphery with a holding trough 4131 formed thereon. The latch trough 412 has an adjacent edge forming a retaining assembly element 414 which has a guiding element 415 with a latch notch 4151 formed thereon and a retaining element 4140 with a sloped side 4141 that can be engaged or disengaged with the latch member 3314 of the rocker bar 331, and released through the guiding element 415. The battery seat 41 has a third electric contact end 416 at an inside of another end to be in contact with the second electric contact end 328, and a depressing element 417 on an outer side. The wedge plate 42 is held in the holding trough 4131 of the detent flange 413, and has an anchor plate 421 extended from one side and an elastic thrust element 422 coupled on another end opposing the anchor plate 421 to push an outer side of the latch arm 3315 so that the rocker bar 331 is under compression. The wedge plate 42 has the bottom extended to another side to form a fourth electric contact end 423 to be in contact with the first electric contact end 327.

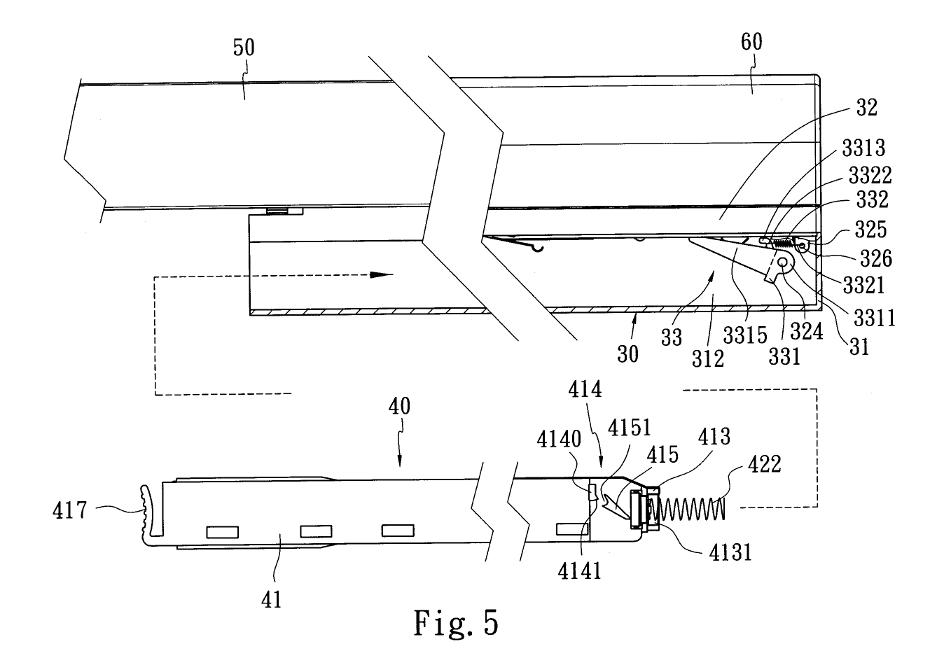

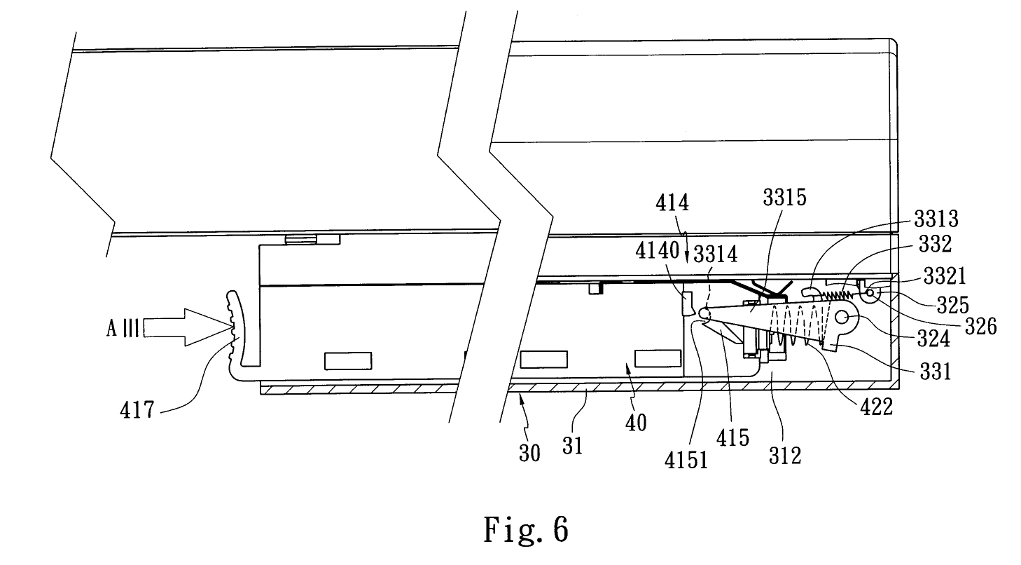

Also referring to FIGS. 5, 6 and 7, the battery pack 40 holds the battery 43 and has one end coupled with the elastic thrust element 422. By pushing the depressing element 417 at another end the battery pack 40 can be loaded in the housing compartment 312 of the battery pack housing 30 in a snap latching fashion. Referring to the drawings, the snap latching is accomplished as follow: the latch hole 326 of the latch element 325 is latched by the hook end 3321 of the elastic element 332. The other end 3322 of the elastic element 332 latches the hook 3313 of the rocker bar 331. The rocker bar 331 is shiftable about the pin 324 running through the coupling end 3311. The latch member 3314 of the latch arm 3315 latches in the latch notch 4151 of the guiding element 415 and is pushed by the elastic thrust element 422 so that the battery pack 40 loaded in the housing compartment 312 is latched on the retaining element 4140 of the retaining assembly element 414, and the first and second electric contact ends 327 and 328 are in contact with the fourth and third electric contact ends 423 and 416 to form electric connection. Therefore the electric window shade 70 (also referring to FIG. 2) can be extended or retracted as desired.

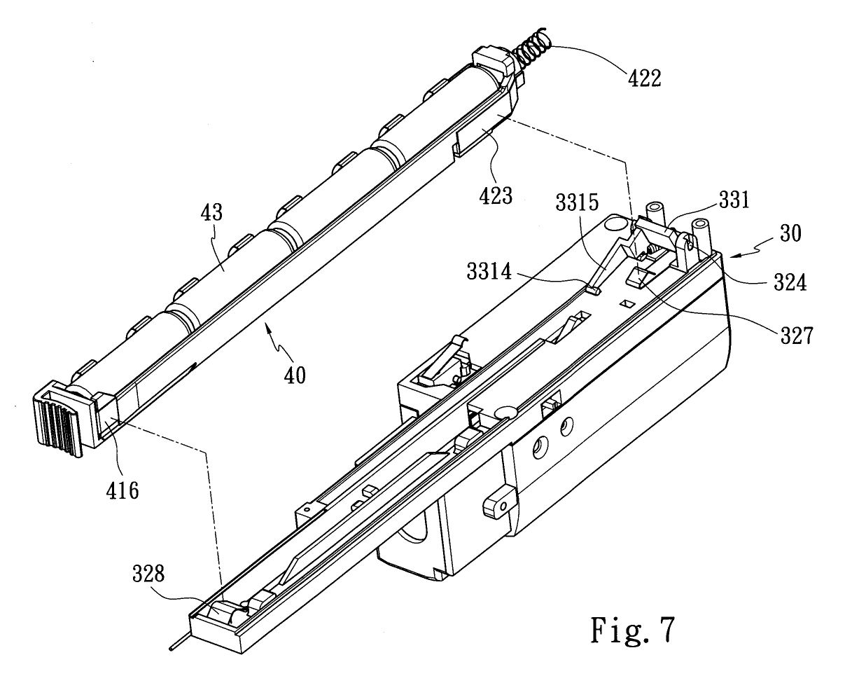

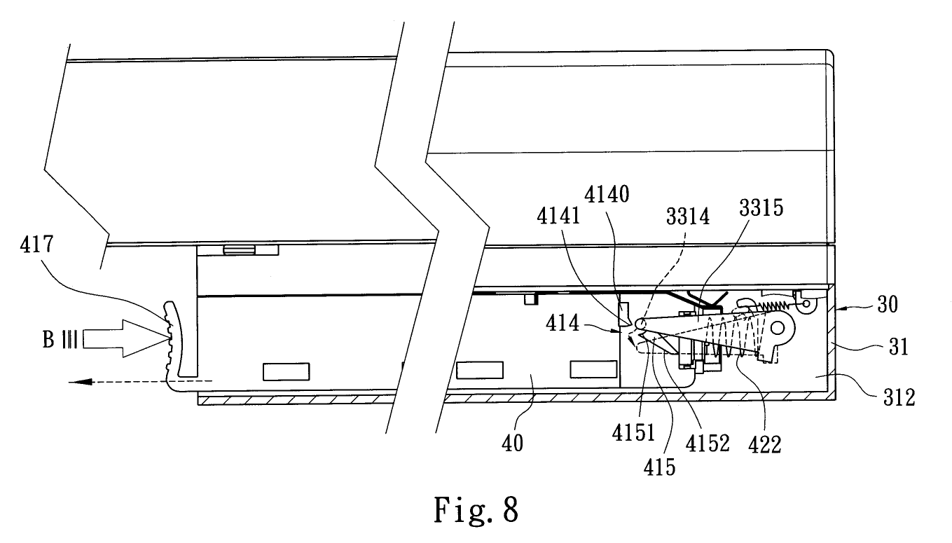

Referring to FIG. 8, when there is a need to change the battery, push the depressing element 417 once, the latch member 3314 latched in the latch notch 4151 under the compression force of the elastic thrust element 422 through the latch arm 3315 of the battery pack housing 30 is urged by the sloped side 4141 and slides downwards along a diagonal side 4152 at the bottom of the guiding element 415. Thus the battery pack 40 is no longer latch on the battery pack housing 30 and can be removed from the housing compartment 312 to change the battery 43 in battery seat 41 (referring to FIG. 7), then be reloaded on the base 31. Hence aside from removing the battery seat 41, changing the battery 43 does not require users to raise their hands.

In the event that the battery pack 40 is removed and not in use, the contact element 61 of the clutch 60 at one end of the battery pack housing 30 is not in contact with the battery seat 41. Then extending or retracting of the window shade can be done manually.

What is claimed is:

1. A battery pack apparatus for electric window coverings coupled with a clutch installed at one side of an upper rail, comprising:
a battery pack housing which is located below the clutch and has a housing compartment hinged inside with a latch assembly element and having an opening end; and
a battery pack which is held in the housing compartment and has a retaining assembly element at one end that has an elastic thrust element at a distal end thereof, the retaining assembly element being lock with the latch assembly element.

2. The battery pack apparatus of claim 1, wherein the battery pack has the retaining assembly element at one end that has the elastic thrust element at a distal end thereof, the retaining assembly element being unlock with the latch assembly element.

3. The battery pack apparatus of claim 1, wherein the clutch has a contact element extended in the housing compartment in contact with the battery pack held in the housing compartment.

4. The battery pack apparatus of claim 1, wherein the battery pack housing has a base and a battery lid coupled to form the housing compartment which has the opening end, the battery lid having a first electric contact end and a second electric contact end.

5. The battery pack apparatus of claim 1, wherein the latch assembly element has a rocker bar and an elastic element.

6. The battery pack apparatus of claim 5, wherein the rocker bar is hinged on one end of the housing compartment and has a coupling end with a hole formed thereon, a hook close to the coupling end latched by another end of an elastic element, and a latch arm at another side with a latch member formed thereon.

7. The battery pack apparatus of claim 1, wherein the battery pack has a battery seat and a wedge plate located on an outer side of one end of the battery seat.

8. The battery pack apparatus of claim 7, wherein the seat has a housing chamber to hold at least one battery and a latch trough at the one end and a detent flange with a holding trough formed on the periphery thereof.

9. The battery pack apparatus of claim 7, wherein the wedge plate has an anchor plate extended from one side and another end opposing the anchor plate coupled with the elastic thrust element and a fourth electric contact end extended from the bottom thereof.

10. The battery pack apparatus of claim 1, wherein the retaining assembly element has a latch notch, a guiding element having a diagonal side and a retaining element having a sloped side that is lock with the latch assembly element, and a third electric contact end at an inner side of another end and a depressing element extended outwards from one side.

11. The battery pack apparatus of claim 1, wherein the retaining assembly element has a latch notch, a guiding element having a diagonal side and a retaining element having a sloped side that is unlock with the latch assembly element.
